(19) United States
(12) Patent Application Publication
(10) Pub. No.: US 2016/0138547 A1
(43) Pub. Date: May 19, 2016

(54) SYSTEM FOR REDUCING WAIT TIME IN STARTING LIQUEFIED PETROLEUM INJECTION ENGINE

(71) Applicants: Hyundai Motor Company, Seoul (KR); KIA MOTORS CORP., Seoul (KR)

(72) Inventors: Hyun KIM, Hwaseong-si (KR); Kwang Seok CHOI, Hwaseong-si (KR)

(21) Appl. No.: 14/933,914

(22) Filed: Nov. 5, 2015

(30) Foreign Application Priority Data
Nov. 14, 2014 (KR) 10-2014-0158622

(51) Int. Cl. F02N 11/08; F02N 19/00

(52) U.S. Cl. CPC F02N 11/08; F02N 19/00; F02N 2019/002

(57) ABSTRACT

a system for starting an LPI vehicle engine includes a signal transmitting unit configured to transmit a door opening signal. A first controller is configured to determine whether an ignition-on state of an engine is required and configured to operate a fuel pump when an ignition-on signal is generated. A second controller is configured to receive the door opening signal transmitted from the signal transmitting unit and configured to operate the fuel pump by transmitting an operation signal corresponding to the ignition-on signal when the door opening signal is input.

### CROSS REFERENCE TO RELATED APPLICATION

The present application claims priority to Korean Patent Application No. 10-2014-0158622, filed Nov. 14, 2014, the entire content of which is incorporated herein for all purposes by this reference.

### TECHNICAL FIELD

The present disclosure relates to a system for starting an LPI engine that is capable of reducing a wait time for faster LPI engine start-up.

### BACKGROUND

Generally, a liquefied petroleum injection (LPI) system enables high-pressure liquefied fuel to be directly injected using a brushless DC (BLDC) electric motor installed in a fuel tank. The LPI system reduces pollutants causing air pollution and solves operational problems, for example, an engine does not start in cold weather. Since the LPI system can increase an engine output power by about 23% compared to an existing LPG system and is an eco-friendly system, the LPI system has recently become widely used.

In order to start a conventional LPI engine, a pressure in a fuel line has to be higher than a reference pressure. That is, the LPI engine start-up requires a certain amount of a wait time until the fuel pressure reaches a required level after an ignition key is turned on, which is different from a multi-point injection (MPI) method. In general, when a vehicle starts by an ignition key, an LPI lamp is lit on an instrument cluster of the vehicle. After a certain period of time elapses, a fuel pressure reaches the reference pressure so that engine start-up is possible, and then the LPI lamp is turned off. After a driver confirms that the LPI lamp is turned off, the driver can start the engine.

As described above, in the conventional LPI vehicle, a fuel pump obtains a sufficient fuel pressure for starting the engine, and a certain period of time is required until the fuel pressure reaches a reference pressure. Therefore, since a driver has to wait for a certain period of time after an ignition key is turned on, the driver may be dissatisfied in the case of the conventional LPI engine.

Further, when the engine forcibly starts before the LPI lamp is turned off, only a starter motor operates and the engine does not start, thus reducing the life of the starter motor.

That is, in the conventional LPI vehicle, because it takes a certain period of time to liquefy gas fuel in a fuel line, a driver has to turn on the ignition key in advance to operate a fuel pump. Then, after the fuel is liquefied in the fuel line, the driver starts the engine. For example, it takes about 6.4 seconds to fill the liquefied fuel.

As described above, due to the characteristics of fuel (LPG gas), the LPI vehicle needs the operation time of a fuel pump for liquefying the fuel before fuel injection. Accordingly, a driver feels inconvenience to wait until the fuel is liquefied after operating a start button (button type) or turning on the ignition key (key type).

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problem, and an aspect of the present inventive concept provides a system for starting an liquefied petroleum injection (LPI) vehicle engine, that is capable of reducing a wait time for LPI engine start-up by liquefying a fuel by operating a fuel pump in advance after detecting a driver's intention to drive and reducing the wait time when starting the engine, thus increasing user convenience.

A system for starting an LPI vehicle engine according to the present disclosure includes a signal transmitting unit configured to transmit a door opening signal. A first controller is configured to determine whether an ignition-on state of an engine is required and configured to operate a fuel pump when an ignition-on signal is generated. A second controller, which is electrically connected with the first controller, is configured to receive the door opening signal transmitted from the signal transmitting unit and configured to operate the fuel pump by transmitting an operation signal corresponding to the ignition-on signal to the first controller when the door opening signal is received.

The signal transmitting unit may be a smart key. When a door opening instruction is input by a driver, the door opening signal may be input to the second controller through a RF receiver.

The first controller may determine whether the ignition-on signal is input and determine an operation of the fuel pump in consideration of a fuel pressure, a fuel temperature, and a saturated vapor pressure chart.

The first controller may be connected with a signal line of the second controller and a signal line of an ignition key switch. When the door opening signal is input from the signal transmitting unit, the second controller may transmit the operation signal to the first controller. The operation signal may be similar to a signal applied when the ignition key switch is turned on.

The operation signal of the second controller may be a voltage that is similar to a voltage applied when the ignition key switch is turned on.

The signal line of the second controller and the signal line of the ignition key switch may be connected to the first controller through a back-current prevention diode.

To reduce time for liquefying a fuel at initial start of an LPI engine, the system for starting the LPI engine predicts driver's intention to drive and liquefies the fuel by operating a fuel pump, thus reducing a wait time for LPI engine start-up and resolving driver's inconvenience.

### BRIEF DESCRIPTION OF THE DRAWINGS

The above and other objects, features and other advantages of the present disclosure will be more clearly understood from the following detailed description taken in conjunction with the accompanying drawings.

FIG. 1 is a block diagram of a system for starting an LPI vehicle engine according to an embodiment of the present inventive concept.

FIGS. 2 to 3 are views for describing a system for starting an LPI vehicle engine according to an embodiment of the present inventive concept.

### DETAILED DESCRIPTION

Hereinafter, a system for starting an LPI vehicle engine is described with reference to the accompanying drawings.

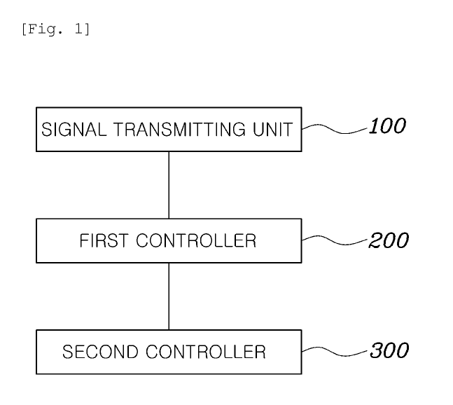

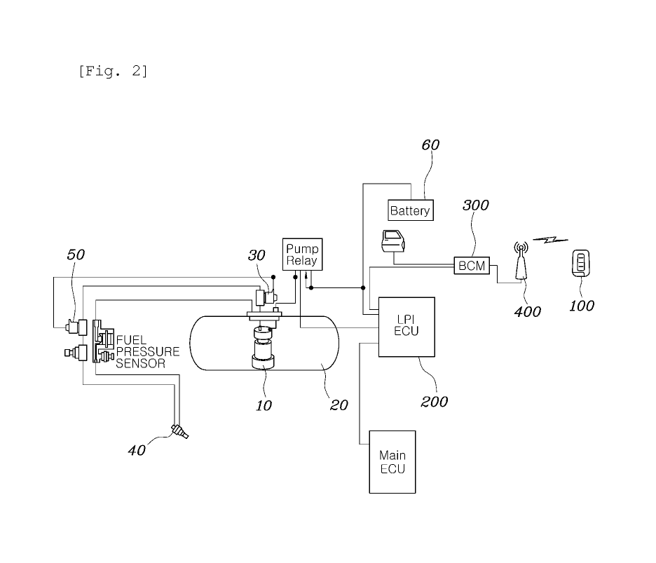

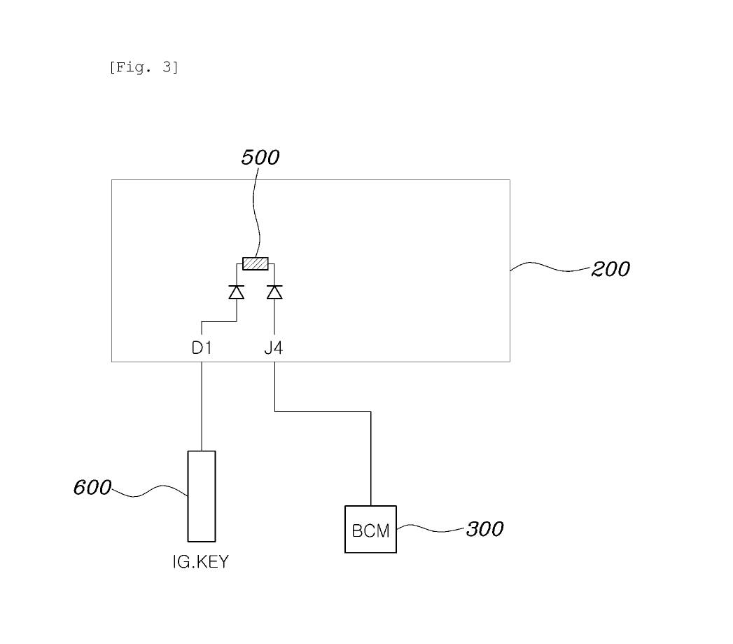

FIG. 1 is a block diagram of a system for starting an LPI vehicle engine according to an embodiment of the present inventive concept. FIGS. 2 to 3 are views for describing a system for starting an LPI vehicle engine according to an embodiment of the present inventive concept.

As illustrated in FIG. 1, a system for starting an LPI vehicle engine according to an embodiment of the present inventive concept includes a signal transmitting unit 100 configured to transmit a door opening signal. A first controller 200 is configured to determine whether an ignition-on state of the LPI engine is required and to operate a fuel pump 10 when an ignition-on signal is generated. A second controller 300 is electrically connected with the first controller 200 and configured to receive the door opening signal transmitted from the signal transmitting unit 100. The second controller 300 is configured further to transmit an operation signal corresponding to the ignition-on signal to the first controller 200 when the door opening signal is input to operate the fuel pump 10.

The system according to the present disclosure operates the fuel pump 10 when a door opening instruction is input by a driver through wireless communication, thus reducing a wait time for a fuel to be liquefied at initial start of the engine. Particularly, in order to operate the fuel pump 10 by controlling an LPI engine controller when the door opening instruction is input, it is necessary to develop a new PCB circuit. However, in the system according to the present disclosure, since the LPI engine controller operates the fuel pump 10 in response to the ignition-on signal, it is possible to operate the fuel pump 10 in response to the door opening instruction without the development of a new PCB circuit, thus reducing development cost.

In detail, the signal transmitting unit 100 may be a smart key, and when the door opening instruction is input by the driver, the door opening signal may be input to a second controller 300 through a radio frequency (RF) receiver 400.

When the driver inputs the instruction for opening a door, the door opening signal is delivered through the RF receiver 400 which is a wireless communication device arranged in the vehicle, whereby the door opening signal is input to the second controller 300. Because the fuel pump 10 is operated when the door opening instruction is input using the signal transmitting unit 100, a wait time, which is a period of time required until the fuel is liquefied after the driver manually turns on the ignition key to operate the fuel pump 10, may be reduced.

When the door opening signal, which is transmitted from the signal transmitting unit 100, is received by the second controller 300, the second controller 300 transmits the operation signal for operating the fuel pump 10 to the first controller 200.

The first controller 200 enables the fuel pump 10 to operate when the ignition-on signal is generated. In addition, the first controller 200 determines whether the ignition-on signal is input, collects information about a fuel pressure and a fuel temperature, and determines the operation of the fuel pump 10 in consideration of saturated vapor pressure depending on a current fuel temperature.

According to the temperature of coolant and the capacity of a battery, an operation time and an operating speed of the fuel pump 10 may be determined. The first controller 200 controls a first solenoid 30 in an liquefied petroleum gasoline (LPG) bombe 20 side and a second solenoid 50 in a sparkplug (engine) 40 side, and may control the operating speed of the fuel pump 10 according to a set fuel condition.

On the other hand, the first controller 200 is connected with a signal line of the second controller 300 and a signal line of an ignition key switch 600. When the door opening signal is input from the signal transmitting unit 100, the second controller 300 may transmit the operation signal, which is similar to a signal applied when the ignition key switch is turned on, to the first controller 200.

Generally, the ignition key switch 600 is installed between a battery 60 and the first controller 200 for controlling the LPI engine. When the ignition key switch 600 is converted to an ON state, the voltage of the battery 60 is supplied to the first controller 200. Namely, the first controller 200 is connected with the signal line of the ignition key switch 600. Here, the first controller 200 may be electrically connected with the signal line of the ignition key switch 600 and the signal line of the second controller 300, which corresponds to a body control module (BCM) of the vehicle.

That is, when the ignition key switch 600 is turned on, the first controller 200 and the battery 60 are electrically connected through the signal line, thus a signal for operating the fuel pump 10 is delivered to the first controller 200. Here, when the door opening signal is input from the signal transmitting unit 100, the second controller 300 transmits the operation signal, which is similar to a signal transmitted when the ignition key switch 600 is turned on, to the first controller 200. As a result, the first controller 200 regards the signal as the signal transmitted when the ignition key switch 600 is turned on, and operates the fuel pump 10, whereby fuel is liquefied by the operation of the fuel pump 10 and a wait time before engine start-up may be reduced.

The operation signal of the second controller 300 may be a voltage that is similar to a voltage applied when the ignition key switch 600 is turned on. When the ignition key switch 600 is turned on, the voltage of the battery 60 is applied to the first controller 200, thus to operate fuel pump 10. Accordingly, when the door opening signal is received from the signal transmitting unit 100, the second controller 300 transmits the voltage similar to the voltage applied when the ignition key switch 600 is turned on during predetermined period of time, whereby the first controller 200 recognizes it as a situation in which the operation of the fuel pump 10 is required. That is, the voltage, which is the operation signal of the second controller 300, and the predetermined period of time are set to enable the first controller 200 when the ignition key switch 600 is turned on.

As described above, in the LPI vehicle, since the first controller 200 controlling the LPI engine operates the fuel pump 10 when the ignition key is turned on, the development cost and time attributable to change of a PCB circuit and control logic of hardware may be reduced.

The signal line of the second controller 300 and the signal line of the ignition key switch 600 may be connected to the first controller 200 through a back-current prevention diode 500.

The back-current prevention diode 500 may be installed within the first controller 200. When current is applied to the signal line of the second controller 300 or the signal line of the ignition key switch 600, the back-current prevention diode 500 prevents a back-current from flowing in other signal lines.

When the current, which is delivered when the ignition key switch is turned on, flows into the second controller 300 via the first controller 200, the engine may be turned off. Therefore, the signal line of the ignition key switch 600 and the signal line of the second controller 300 are connected through the back-current prevention diode 500 within the first controller 200, whereby the back-current is prevented and the stability and durability of components may be secured.

As described above, to reduce the amount of time for liquefying fuel when starting an LPI vehicle engine, the system for starting an LPI vehicle engine according to the present disclosure predicts driver's intention to drive and liquefies the fuel by operating a fuel pump 10, thus reducing the wait time for LPI engine start-up and resolving driver's inconvenience.

In general, in order to operate the fuel pump 10 by controlling an LPI engine controller when a door opening instruction is input, it is necessary to develop a new PCB circuit. However, the system according to the present disclosure enables the fuel pump 10 to operate in response to the door opening instruction by a driver without the development of a new PCB circuit by using the characteristic that the LPI engine controller operates the fuel pump 10 when an ignition-on signal is input, thus reducing development time and cost.

Although the exemplary embodiments of the present inventive concept have been disclosed for illustrative purposes, those skilled in the art will appreciate that various modifications, additions, and substitutions are possible, without departing from the scope and spirit of the invention as disclosed in the accompanying claims.

What is claimed is:

1. A system for starting a liquefied petroleum ignition (LPI) vehicle engine, comprising:
a signal transmitting unit configured to transmit a door opening signal;
a first controller configured to determine whether an ignition-on state of the engine is required and for operating a fuel pump when an ignition-on signal is generated; and
a second controller, which is electrically connected with the first controller, configured to receive the door opening signal transmitted from the signal transmitting unit and configured to operate the fuel pump by transmitting an operation signal, which corresponds to the ignition-on signal, for operating the fuel pump to the first controller when the door opening signal is received.

2. The system of claim 1, wherein the signal transmitting unit is a smart key, and
when a door opening instruction is input by a driver using the signal transmitting unit for opening a vehicle door, the door opening signal, which corresponds the door opening instruction, is input to the second controller through a radio frequency (RF) receiver.

3. The system of claim 1, wherein the first controller determines whether the ignition-on signal is input and determines the operation of the fuel pump in consideration of a fuel pressure, a fuel temperature, and a saturated vapor pressure chart.

4. The system of claim 1, wherein the first controller is connected with a signal line of the second controller and a signal line of an ignition key switch, and
when the door opening signal is input from the signal transmitting unit, the second controller transmits the operation signal to the first controller, the operation signal being similar to a signal applied when the ignition key switch is turned on.

5. The system of claim 4, wherein the operation signal of the second controller is a voltage that is similar to a voltage applied when the ignition key switch is turned on.

6. The system of claim 4, wherein the signal line of the second controller and the signal line of the ignition key switch are connected to the first controller through a back-current prevention diode.

7. The system of claim 1, wherein the first and second controllers are engine control units containing hardware and software.

8. The system of claim 1, wherein the ignition-on signal is generated when a driver presses a start button or turns on an ignition key to turn on the ignition key switch.
